(19) United States
(12) Patent Application Publication
(10) Pub. No.: US 2007/0184255 A1
(43) Pub. Date: Aug. 9, 2007

(54) Electric insulating prepreg applied to fuel cell

(75) Inventors: Joshua Chiang, Taipei (TW); Ming-Tung Lin, Taipei (TW); Chih-Ming Chang, Taipei (TW); Pi-Feng Chang, Taipei (TW); Shi-Shyan Shang, Luchu Shiang (TW); Ching-Sen Yang, Luchu Shiang (TW)

Correspondence Address: BACON & THOMAS, PLLC, 625 SLATERS LANE, FOURTH FLOOR, ALEXANDRIA, VA, 22314, US

(73) Assignees: NAN YA PLASTICS CORPORATION, Taipei (TW); NAN YA PRINTED CIRCUIT BOARD CORPORATION, Luchu Shiang (TW)

(21) Appl. No.: 11/701,412

(22) Filed: Feb. 2, 2007

(30) Foreign Application Priority Data
Feb. 7, 2006 (TW) 095104065

(51) Int. Cl. D04H 13/00; B32B 27/04; B32B 17/02

(52) U.S. Cl. 428/292.1; 428/297.4; 428/299.4

(57) ABSTRACT

A prepreg for fuel cell obtained by soaking reinforcing glass fiber cloth in resin mixture and having the soaked cloth pre-dried to form incompletely cured prepreg which can be press-cured under temperature range of 60□˜200□ to provide good mechanical and electrical property and high bonding strength, and when applied to fuel cell for bonding together the parts and components of the fuel cell the prepreg can also provide the effect of preventing crossover of fuel of the fuel cell and helping to the normal operation of the fuel cell.

### BACKGROUND OF THE PRESENT INVENTION

1. Field of the Present Invention

The invention relates to a prepreg, particularly the prepreg applied to fuel cell for bonding together the parts and components of fuel cell and preventing crossover of fuel of the fuel cell.

2. Description of Prior Act

In recently years, owing to the increasing attention paid by the public to environmental protection and energy saving the fuel cell which possesses the advantages of high efficiency and low pollution hazard to the environment has become the focal-technology on which countries in Europe and America as well as Japan all rush on doing research and development.

Among the fuel cells the Direct Methanol Fuel cell or abbreviated as DMFC has largely improved its portability and safety by adopting liquid methanol to form fuel system in place of using hydrogen gas which has been used in the past, and therefore the field of application of notebook PC, cell phone and 3C products of fuel cell has been extended to include motor vehicles and motorcycles, family appliances and military application that attracted the attention of the countries in the world to invest in the research and development of this type of fuel cell.

However if conventional type of mechanical structure is employed on the methanol fuel cell for bonding together the parts and components to prevent crossover of methanol fuel such as using the combination of graphite material and packing sheet, the drawbacks of large size and high cost are detrimental to making the methanol fuel cell a compact size and commercial usage.

### SUMMARY OF THE PRESENT INVENTION

In order to solve the problem as mentioned above the invention discloses a prepreg special for fuel cell. The prepreg is made of reinforced glass fiber cloth soaked with resin mixture and pre-dried by oven to form an incompletely cured B-stage prepreg which can be press-cured under temperature range of 60□˜200□. Especially, the prepreg can be employed by fuel cell industry, and applied to the manufacturing of fuel cell including methanol fuel cell. By press-curing process the prepreg can be employed for bonding together the parts and components of fuel cell, and the prepreg after curing has the effect of preventing crossover of fuel that can enable a normal operation of fuel cell such as methanol fuel cell as well as the advantage of low cost and compact size.

### BRIEF DESCRIPTION OF THE DRAWING FIGURES

FIG. 1 is an enlarged sectional view of the structure of Fuel cell which employs the prepreg of the invention; it shows that the prepreg of the invention can be employed to bond together the parts and components, and can effectively prevent crossover of fuel of fuel cell.

### DETAILED DESCRIPTION OF THE PREFERRED EMBODIMENTS

The prepreg disclosed in the invention is made of composite material formed by having reinforced glass fiber cloth soaked with resin mixture which makes up 30˜95% of the total weight of the prepreg, and after soaked with resin mixture the glass fiber cloth is pre-dried by oven to form incompletely cured prepreg.

This kind of incompletely cured prepreg has the characteristics of tack free, high sovability and meltability, and can be press-cured under temperature range of 60□˜200□. When the prepreg is pressed and heated the resin mixture of the prepreg of the invention can be cured through chemical reaction, i.e. after heat press-cure process the prepreg of the invention can provide good mechanical and electrical property and high bonding strength.

The prepreg disclosed in the invention uses glass fiber cloth as reinforcement which may be the cloth made of continuous glass fiber, or my use non-woven glass fiber mat, or paper or synthetic fiber mat as reinforcement instead of the aforesaid fiber cloth.

The resin mixture used for soaking the glass fiber cloth of the invention is a mixture containing Epoxy Resin (a) and curing Agent (b). However accelerator (c) and/or additives (d) may be added in whenever necessary. The proportion between each component of the resin mixture is as follows:
(a) EPOXY resin: makes up 20˜99 Wt % of the total solid of the resin mixture with Epoxy Equivalent Weight (EEW) approximately 150˜10000 g/eq. The epoxy resin used can be Bisphenol A type epoxy resin, Bisphenol F type epoxy resin or Tetra-function epoxy resin or Multi-function epoxy resin or more than one of the above.
   In addition, in order to enable the prepreg of the invention the effect of fire-resistance the Brominated epoxy resin or Phosphureted epoxy resin which is fire-resisting resin can also be used. However if Brominated epoxy resin or Phosphureted epoxy resin is not used, the fire-resisting effect can also be achieved by using curing agent (c) or additives (d).
(b) Curing agent makes up 1˜60 wt % of the total solid of the resin mixture. The curing agent used includes Amine compounds such as 4,4′-methylene dianiline (MDA), diamino diphenyl sulphone (DDS), benzyl dimethyl amine (BDMA); Imidazole compounds of 2-Methyle imidazole (2MI); acide anhydrides; phenol novolak; dicyandiamide (DICY); Boron trifluoride monethylamine (BF₃MEA) etc.
   Among these curing agents the most preferred embodiment is dicyandiamie (DICY). This is because of the low hydroxyl equivalent of DICY that results in only less amount of the curing agent is needed, and therefore can help to the enhancing of its fire-resistance.
(c) Accelerator makes up 0˜30 Wt % of the total solid of the resin mixture. The accelerator used includes Imidazole compounds such as 2-Methyl imidazole (2MI), 2-Phenyl imiclazole (2PI), 2-Ethyl-4-Methyl imidazole (2E4MZ); Boron trifluoride monethylamine (BF₃MEA); Amine compounds such as Benzyl dimethyl amine (BDMA) etc.
   The use of accelerator is for enhancing the reaction of cross linking between resin epoxy and curing agent. The amount of accelerator used will affect the speed of reaction. Greater amount of accelerator can reduce and decrease the time and temperature of press-bonding, but can also narrow the working window.
(d) Additives makes up 0˜80 Wt % of the total solid. The additive used includes organic additives, inorganic additives, engineering plastics, defoamer, flattening agent etc.
   The use of additives depends on the requirement of the characteristic of the prepreg. In order to make the prepreg of the invention more regid inorganic additives such as clay, SiO₂, CaCO₃, TiO₂, or Al(OH)₃ can be add into the prepreg.
   Or, if the characteristic of fire-resistance is to be improved brominated organic compounds, phosphureted organic compounds and phosphueted inorganic compounds etc. can be added into the prepreg.

Besides, in order to meet the requirements on operation and outer appearance defoamer, flattening agent and tackifier can be added into the resin mixture for soaking the glass fiber cloth. And, in some cases engineering plastics or modified engineering plastics can be used for some specific purpose.

The solvent for preparing the resin mixture must be those which can dissolve resin epoxy such as acctone (DMK), methyl ethyl ketone (MEK), Toluene, xylene, propylene glycol monomethyl ether (PM), Propylene glycol methyl ether acetate (PMA), and dimethyl formamide (DMF) etc.

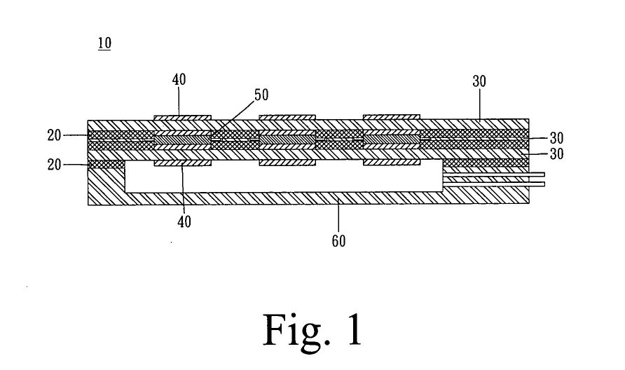

Shown in FIG. 1 is the prepreg (20) of the invention for being used as bonding material during the manufacturing process of fuel cell 10. Particularly, during the manufacturing of direct methanol fuel cell (DMFC) the prepreg of the invention can be placed between frame 30, bipolar board 40, membrane electocde assembly (MEA) 50 and fuel storage 60 as bonding material. After press-cure under temperature range of 60□˜200□ the prepreg 20 of the invention will bond together the frame 30, bipolar board 40, membrane electrode assembly 50 and fuel storage 60 to form a direct methanol fuel cell 10.

In addition to bonding together the parts and components to form a fuel cell 10 the prepreg 20 of the invention possesses good mechanical and electrical property and high bonding strength, therefore it can also effectively prevent crossover of the fuel of fuel cell 10 and enable a normal operation of fuel cell 10. Moreover, the prepreg 20 of the invention helps to enabling the fuel cell the superiority of compact size and lower cost.

In the following, described in example 1 through example 4 are the preferred embodiment of the prepreg of the invention in which the major composition of the resin mixture for soaking the glass fiber cloth contains Epoxy resin (a); Curing agent (b); Accelerator (c); and additives (d), particularly the Epoxy resin is made of different kinds of raw material mixed in different proportions.

The prepreg shown in example 1 through example 4 are tested for bonding strength and resin flow by applying Adhesion test method and Resin flow test method. The test results are shown in Table 1.

Adhesion test method: Stack the copper foil base plate (CCL), pre-dried incompletely cured prepreg and frame in order, then cure the stacked material and parts with hot press machine to have the material completely cured, and then test the finished prepreg by universal tensile test machine.

Resin flow test method: Cut the pre-dried incompletely cured prepreg into appropriate size, then bond the prepreg sheets by hot press machine, and then measure the size of the resin flow of the press-bonded prepreg.

### EXAMPLE 1

Measure 84 Wt % Brominated epoxy resin (EEW: 425 g/eq, Nan Ya Plastic Corp., Product No.: NPEB-454), 13 Wt % liquid Epoxy resin (EEW: 185 g/eq, Nan Ya Plastics Corp., Product No.: EL-128) without tanking into account the solvent, and mixed them with 2.8 wt % DICY and 0.2 wt % 2MI, and then dissolve the mixture in the solvent of acetone and dimethyl formamide and adjust the solution into varnish with solid contained at 60˜70 wt %. Soak the glass fiber cloth 7628 in the varnish and then put the glass fiber cloth in oven. The proportion of cloth to resin is controlled at 1:1. The glass fiber cloth is pre-dried into incompletely cured prepreg, and then cure the prepreg with hot-press machine.

### EXAMPLE 2

Same as the procedure of example 1 except added into the varnish 10 wt % SiO₂ powder.

### EXAMPLE 3

Measure 89 Wt % Phosphureted epoxy resin (EEW: 360 g/eg, Nan Ya Plastics Corp. Product No.: NPEP-200), 10 Wt % liquid Epoxy resin (EEW: 185 g/eg, Nan Ya Plastics Corp., Product No.: EL-128) without taking into account the solvent and then mixed with 1 Wt % 2MI, and then dissolve the mixture in the solvent of acetone and DMF, and the solution is adjusted into varnish containing solid of 60˜70 Wt %; then soak the glass fiber cloth 7628 in the varnish with proportion of cloth to resin controlled at 1:1, and put the soaked glass fiber cloth in oven for drying. The incompletely cured prepreg is then removed from oven, and press-cured by hot press machine.

### EXAMPLE 4

Measure 20 Wt % Epoxy resin (Nan Ya Plastics Corp., product No.: NPEL-128), 12.5 Wt % Phonol Novolak curing agent (BORDEN, Product No.: SD-1502), 20 Wt % Tetra bromo bisphenol-A (TBBA), 12.5 Wt % engineering plastics, 34.5 Wt % Al (OH)₃ and 0.5 Wt % 2-Ethyl-4-methyl imidazole (2E4MZ) without taking into account the solvent, and dissolve the mixture in acetone and PM, and then adjust the mixture into varnish containing solid of 60˜70 Wt %, then soak the glass fiber cloth 2116 in the varnish with the proportion of cloth to resin controlled at 1:1, and put the soaked cloth in oven for pre-drying. The incompletely cured prepreg is then removed from oven and press cured by hot press machine.

### COMPARISON EXAMPLE

Measure 61.5 Wt % Bronminated Epoxy resin, 9.8 wt % liquid Epoxy resin, mixed with 28.7 wt % acid anhydride curing agent (MTHPA) and 0.04 wt % Benzyl dimethyl amine (BDMA), and have these materials mixed and blended into uniform mixture. Then apply the resin mixture on glass fiber cloth by silk screen printing machine, and have the cloth cured by hot press machine.

TABLE 1

| | Bonding | | | |
|---|---|---|---|---|
| | Strength | Resin flow | Price | Weight |
| Example 1 | ◯ | ◯ | Low | Light |
| Example 2 | ◯ | ◯ | Low | Light |
| Example 3 | ◯ | ◯ | Low | Light |
| Example 4 | ◯ | ◯ | Low | Light |
| Comparison | ◯ | X | Low | Light |
| example 1 | | | | |
| Traditional | — | — | Height | Heavy |
| graphite Method | | | | |

◯: Represents good
X: represents not good

According to the test results in Table 1 the prepreg of the invention using reinforcing material (glass fiber cloth) soaked with resin mixture after hot press curing can effectively control the resin flow and provide good bonding strength, and can enable lower production cost as compared with that produced by traditional graphite method. Therefore the prepreg disclosed in the invention can be applied to fuel cell to provide the effect of bonding together the components and parts, and preventing crossover of fuel of fuel cell.

What is claimed is:

1. A prepreg applied for fuel cell obtained by soaking a reinforcing glass fiber cloth in resin mixture and pre-drying the soaked cloth to form incompletely cured bonding material which shall be press-cured under temperature range of 60˜200□ with an amount of the resin mixture used making up 30˜95% of the total weight of the prepreg and the major components of the resin mixture comprises:
(a) epoxy resin makes up 20˜99 wt % of the total solid of the resin mixture with an equivalent epoxy weight of 150˜10000 g/eq approximately;
(b) curing agent makes up 1˜60 wt % of the total solid of the resin mixture;
(c) accelerator makes up 0˜30 wt % of the total solid of the resin mixture; and
(d) additives makes up 0˜80 wt % of the total solid of the resin mixture.

2. The prepreg as described in claim 1, wherein the fiber glass cloth comprises the cloth made of continuous glass fiber by weaving process or the non-woven glass fiber mat or paper or synthetic fiber.

3. The prepreg as described in claim 1, wherein the epoxy resin (a) is Bisphenol A type epoxy resin, Bisphenol F type epoxy resin, Tetra-function epoxy resin, Multi-function epoxy resin, Brominated epoxy resin or Phosphureted epoxy resin; or more than one of the above.

4. The prepreg as described in claim 1, wherein the curing agent (b) of the resin mixture are Amine compounds of MDA or DDS or Benzyl dimethyl amine (BDMA) and the Imidazole compounds such as 2MI, or Acid anhydrides or Phenol novolak or DICY or BF₃MEA or more than one of the above.

5. The prepreg as described in claim 1, wherein the accelerator (c) is Imidazole compounds including 2MI, 2PI, 2E4MZ or BF₃MEA; or Amine compounds including benzyl dimethyl amine (BDMA); or more than one of the above.

6. The prepreg as described in claim 1, wherein the additives (d) are organic additives, inorganic additives, engineering plastics, defoamer or flattening agent; or more than one of the above.

7. The prepreg as described in claim 6, wherein the inorganic additives are clay, SiO₂, CaCO₃, TiO₂, Al(OH)₃ or more than one of the above.

8. The prepreg as described in claim 6, wherein the organic additives are brominated additives or phosphureted additives or modified engineering plastics or non-modified engineering plastics or more than one of the above.
